(19) United States
(12) Patent Application Publication
(10) Pub. No.: US 2026/0212831 A1
(43) Pub. Date: Jul. 23, 2026

(54) DISPLAY DEVICE

(71) Applicant: LG Display Co., Ltd., Seoul (KR)

(72) Inventors: Duckkyu LIM, Daegu (KR); Seunghyeon BYEON, Gimpo-si (KR)

(21) Appl. No.: 19/424,878

(22) Filed: Dec. 18, 2025

(30) Foreign Application Priority Data
Jan. 23, 2025 (KR) 10-2025-0009968

(51) Int. Cl. G09G 3/3275; G09G 3/20; G09G 3/3233

(52) U.S. Cl. CPC G09G 3/3275; G09G 3/2007; G09G 3/2096; G09G 3/3233; G09G 2300/0842; G09G 2320/0233; G09G 2320/0242; G09G 2320/041; G09G 2330/028; G09G 2370/08

(57) ABSTRACT

A display device for minimizing luminance and color coordinate deviations by adaptively reflecting compensation voltages for each driving frequency and band. The display device includes a data driver for transmitting a control signal that causes a gamma generator to generate a gamma compensation voltage based on a driving frequency and a band, acquiring a gamma compensation voltage from the gamma generator, and applying the acquired gamma compensation voltage to each pixel through a data line. Accordingly, the display device can increase the accuracy of voltage compensation and minimize luminance deviations.

### CROSS REFERENCE TO RELATED APPLICATION

This application claims priority from and the benefit of Korean Patent Application No. 10-2025-0009968, filed on Jan. 23, 2025, which is hereby incorporated by reference for all purposes as if fully set forth herein.

### BACKGROUND

### Field

Embodiments of the invention relate generally to a display device, and more particularly, to a display device capable of minimizing luminance and color coordinate deviations by adaptively reflecting compensation voltages for each driving frequency and band.

### Discussion of the Background

Image display devices that display various pieces of information on a screen are evolving toward thinner, lighter, more portable, and higher performance displays. Accordingly, lightweight and slim display devices are attracting attention.

Such display devices are not only advantageous in terms of power consumption due to low-voltage operation, but also have high-speed response times, high luminous efficiency, excellent viewing angles, and excellent contrast ratios and, thus, are being studied as next-generation displays. These display devices implement images through a plurality of sub-pixels arranged in a matrix form. Each of the plurality of sub-pixels may include a light-emitting element and pixel circuits, such as a plurality of transistors, which independently drive the light-emitting element.

Examples of such flat panel display devices include a liquid crystal display (LCD) device, an organic light-emitting diode (OLED) display device, a micro light-emitting diode (LED) display device, a quantum dot display device, etc.

Among these displays, the OLED display device, which is gaining popularity for enabling device miniaturization and vivid color expression without requiring a separate light source, offers advantages such as fast response speed, a high contrast ratio, luminous efficiency, luminance, a wide viewing angle, and the like due to its self-emissive OLED.

The OLED display device can have pixels each including an OLED arranged in a matrix form and control luminances of the pixels based on the gradation of image data. Each pixel includes a driving transistor that controls a driving current flowing through the OLED according to a gate-to-source voltage. The luminance of the pixel is proportional to the magnitude of the driving current flowing through the OLED.

A display panel formed of a low-temperature polycrystalline oxide (LTPO) tends to exhibit greater luminance variation in response to temperature fluctuations compared to low-temperature polycrystalline silicon (LTPS).

In addition, the optical characteristics of the OLED display device can vary depending on various process factors. For example, when voltages or currents of different magnitudes are applied to display panels of the same model, the color coordinates and luminances of the images displayed on each panel can be different. Conventional LTPO display panels exhibit greater luminance fluctuations in response to temperature fluctuations than LTPS, resulting in different directions of luminance fluctuations at different luminance levels depending on temperature fluctuations.

Accordingly, there is a need to compensate for deviations in optical characteristics among display panels.

The above information disclosed in this Background section is only for understanding of the background of the inventive concepts, and, therefore, it may contain information that does not constitute prior art.

### SUMMARY

Display devices according to embodiments of the invention are capable of minimizing luminance deviations by increasing the accuracy of data voltage compensation due to panel temperature fluctuations.

Additional features of the inventive concepts will be set forth in the description which follows, and in part will be apparent from the description, or may be learned by practice of the inventive concepts.

According to one or more embodiments of the invention, a display device includes a display panel including a plurality of pixels, and gate lines and data lines electrically connected to each pixel, a gate driver for transmitting gate signals to each pixel through the gate line, a data driver for transmitting data voltages to each pixel through the data line, and a gamma generator for generating a gamma compensation voltage based on a driver driving voltage. The data driver generates a control signal that causes the gamma generator to generate a gamma compensation voltage based on a driving frequency and band of the display panel and transmit the generated control signal to the gamma generator.

The data driver may acquire the gamma compensation voltage generated by the gamma generator based on the control signal and transmit a data voltage corresponding to the acquired gamma compensation voltage to each pixel through the data line.

The display device may further include a timing controller for transmitting an image signal and a data driving control signal to the data driver.

The data driver may identify a driving frequency for the image signal through the data driving control signal received from the timing controller.

The data driver may include a memory for storing gamma compensation voltages corresponding to reference temperatures for each driving frequency and each band of the display panel.

The memory may store gamma compensation voltages corresponding to reference temperatures for each driving frequency and each band of the display panel in a register.

The memory may store offset values for a plurality of temperatures within a predetermined temperature range for optical compensation of the display panel.

The data driver may set a plurality of reference temperatures based on the driving frequency information and band information of the display panel and may generate the data voltage by reflecting the offset values corresponding in each of the plurality of set reference temperatures.

The reference temperature may be set for each band and stored in the memory.

According to yet another embodiment of the invention, a display device including a display panel includes a plurality of pixels, a data driver for transmitting a data voltage to each pixel, and a timing controller for transmitting an image signal and a data driving control signal to the data driver. The data driver may receive an identification signal for identifying a gamma compensation voltage based on the driving frequency and band of the display panel from the timing controller and identify the gamma compensation voltage based on the received identification signal.

The data driver may identify the gamma compensation voltage based on the identification signal and transmit a data voltage corresponding to the identified gamma compensation voltage to each pixel.

The data driver may include a memory for setting a plurality of f reference temperatures based on the driving frequency information and band information of the display panel, and storing gamma compensation voltages corresponding to each of the plurality of set reference temperatures.

The memory may store gamma compensation voltages corresponding to reference temperatures for each driving frequency and each band of the display panel in a register.

The data driver may acquire a gamma compensation voltage corresponding to image data displayed on the display panel from the memory and transmit a data voltage corresponding to the acquired gamma compensation voltage to each pixel through a data line disposed on the display panel.

The memory may store offset values for a plurality of temperatures within a predetermined temperature range for optical compensation of the display panel.

The data driver may generate data voltages by reflecting offset values for each of the plurality of temperatures within the predetermined temperature range in reference temperatures according to each driving frequency and each band of the display panel.

The reference temperature may be set for each band and stored in the memory.

According to yet another embodiment of the invention, a method of minimizing luminance and color coordinate deviation in pixels of a display panel in a display device including a data driver for transmitting a data voltage to each pixel through a data line, and a gamma generator, includes: generating, by the data driver, a control signal that causes the gamma generator to generate a gamma compensation voltage based on a driving frequency and band of the display panel; transmitting, by the data driver, the control signal to the gamma generator; generating, by the gamma generator, the gamma compensation voltage based on the driving frequency and the band of the display panel; acquiring, by the data driver, the gamma compensation voltage based on the control signal; and transmitting, by the data driver, a data voltage corresponding to the acquired gamma compensation voltage to each pixel through the data line.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a block diagram illustrating a configuration of a display device according to an embodiment of the invention.

FIG. 2 is a schematic view illustrating a circuit of a sub-pixel of the display device according to an embodiment of the invention.

FIG. 3 is a block diagram illustrating a configuration of a data driver according to an embodiment of the invention.

FIG. 4 is a view illustrating a configuration of a gamma generator according to an embodiment of the invention.

FIG. 5 is an exemplary view illustrating a configuration of a gamma voltage generator according to an embodiment of the invention.

FIG. 6 is an exemplary view illustrating data voltages according to five temperatures stored in the data driver according to an embodiment of the invention.

FIG. 7 is an exemplary view illustrating five temperatures stored in the data driver according to an embodiment of the invention.

FIG. 8 is an exemplary graph illustrating an optical compensation temperature profile according to an embodiment of the invention.

FIG. 9 is an exemplary graph illustrating a curve of data voltages stored in the data driver according to an embodiment of the invention.

FIG. 10 is an exemplary view illustrating driving frequencies and band-specific reference temperatures stored in a memory of the data driver according to an embodiment of the invention.

FIG. 11 is a graph illustrating band-specific dimming levels of pixel circuits in the display device according to an embodiment of the invention.

FIG. 12 is a view illustrating a method of adjusting band-specific dimming levels of the pixel circuits in the display device according to an embodiment of the invention.

FIG. 13A and FIG. 13B are views showing the results of reducing the dispersion of color coordinates and luminance through gamma compensation voltages corresponding to reference temperatures for each driving frequency and each band according to an embodiment of the invention.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As is customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

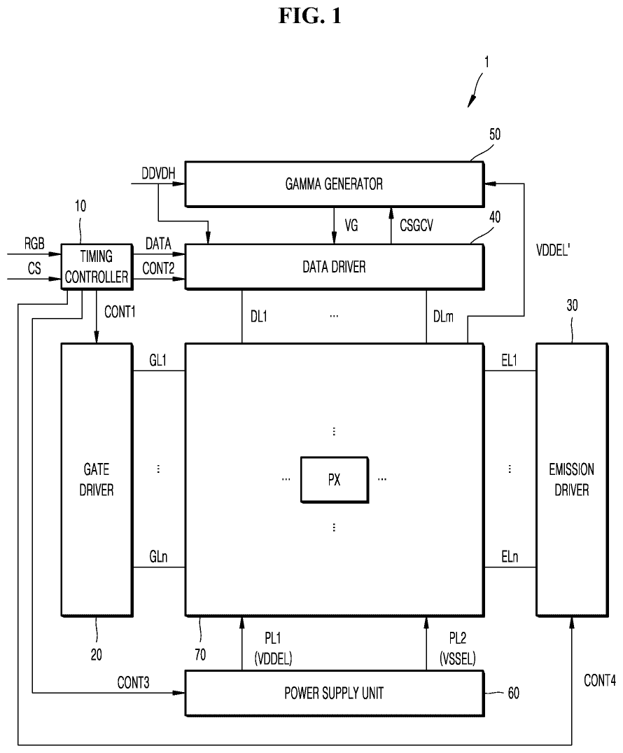

FIG. 1 is a block diagram illustrating a configuration of a display device according to an embodiment of the invention.

Referring to FIG. 1, a display device 1 includes a timing controller 10, a gate driver 20, an emission driver 30, a data driver 40, a gamma generator 50, a power supply unit 60, and a display panel 70.

According to an embodiment, the timing controller 10 may receive image signals RGB and control signals CS from the outside. The image signals RGB may include a plurality of grayscale data. The control signals CS may include, for example, a horizontal synchronization signal, a vertical synchronization signal, and a main clock signal.

In addition, the timing controller 10 may transmit an identification signal for identifying a gamma compensation voltage depending on the temperature based on a driving frequency and band of the display panel 70 to the data driver 40.

The timing controller 10 may process the image signals RGB and the control signals CS under operating conditions of the display panel 70 to generate image data DATA and a data driving control signal CONT2, transmit the image data DATA and the data driving control signal CONT2 to the data driver 40, and generate a gate driving control signal CONT1 and transmit the gate driving control signal CONT1 to the gate driver 20. In addition, the timing controller 10 may generate a power supply control signal CONT3 and transmit the power supply control signal CONT3 to the power supply unit 60, and generate an emission driving control signal CONT4 and transmit the emission driving control signal CONT4 to the emission driver 30.

According to an embodiment, the gate driver 20 may be electrically connected to pixels PX (or sub-pixels) of the display panel 70 through a plurality of gate lines GL1 to GLn. The gate driver 20 may generate gate signals based on the gate driving control signal CONT1 output from the timing controller 10. The gate driver 20 may provide the generated gate signals to the pixels PX through the plurality of gate lines GL1 to GLn.

According to an embodiment, the emission driver 30 may be electrically connected to the pixels PX of the display panel 70 through a plurality of emission lines EL1 to ELn. The emission driver 30 may generate emission signals based on the emission driving control signal CONT4 output from the timing controller 10. The emission driver 30 may provide the generated emission signals to the pixels PX through the plurality of emission lines EL1 to ELn.

According to an embodiment, the data driver 40 may be electrically connected to the pixels PX of the display panel 70 through a plurality of data lines DL1 to DLm. The data driver 40 may generate data voltages based on the image data DATA and the data driving control signal CONT2 output from the timing controller 10.

According to an embodiment, the data driver 40 may generate a control signal CSGCV for generating gamma reference voltages based on temperatures according to frequencies and bands, and transmit the generated control signal CSGCV to the gamma generator 50. In addition, the gamma generator 50 may generate gamma compensation voltages VG using the control signal CSGCV transmitted from the data driver 40 and transmit the gamma compensation voltages VG to the data driver 40.

According to an embodiment, the data driver 40 may receive the gamma compensation voltages VG generated by the gamma generator 50 and select a voltage corresponding to the grayscale of the image data DATA among the gamma compensation voltages VG to generate a data voltage. The data driver 40 may provide the generated data voltages to the pixels PX through the plurality of data lines DL1 to DLm.

According to an embodiment, the gamma generator 50 may generate the gamma compensation voltages VG based on a driver driving voltage DDVDH generated by the power supply unit 60. For example, the gamma generator 50 may generate the gamma compensation voltages VG based on a feedback voltage VDDEL′ for a high potential driving voltage VDDEL applied from the display panel 70. The gamma generator 50 may transmit the generated gamma compensation voltages VG to the data driver 40.

According to an embodiment, the power supply unit 60 may be electrically connected to the pixels PX of the display panel 70 through a plurality of power lines PL1 and PL2. The power supply unit 60 may generate a driving voltage to be provided to the display panel 70 based on the power supply control signal CONT3. The driving voltage may include, for example, a high potential driving voltage VDDEL and a low potential driving voltage VSSEL. The power supply unit 60 may provide the generated driving voltages VDDEL and VSSEL to the pixels PX through the corresponding power lines PL1 and PL2.

According to an embodiment, the power supply unit 60 may further generate the driver driving voltage DDVDH for driving the data driver 40 and the gamma generator 50. The power supply unit 60 may supply the generated driver driving voltage DDVDH to the data driver 40 and the gamma generator 50.

According to an embodiment, the plurality of pixels PX (also referred to as “sub-pixels”) are disposed on the display panel 70. For example, the pixels PX may be arranged in a form of a matrix on the display panel 70.

Each pixel PX may be electrically connected to a corresponding gate line, emission line, and data line. These pixels PX may emit light with a luminance corresponding to the gate signal, emission signal, and data voltage supplied through the gate lines GL1 to GLn, the emission lines EL1 to ELn, and the data lines DL1 to DLm.

Each pixel PX may display one of first to third colors. In one embodiment, each pixel PX may display one of red R, green G, and blue B. In another embodiment, each pixel PX may display one of cyan, magenta, and yellow. In various embodiments, the pixels PX may be formed to display one of four or more colors. For example, each pixel PX may display one of red R, green G, blue B, and white W.

According to an embodiment, the timing controller 10, the gate driver 20, the data driver 40, and the power supply unit 60 may each be configured as a separate integrated circuit (IC), or at least some thereof may be integrated into a single integrated circuit. For example, at least some of the timing controller 10, the data driver 40, the gamma generator 50, and the power supply unit 60 may be configured as an integrated circuit. Such an integrated circuit may be implemented, for example, in the form of a flexible printed circuit board (FPCB).

FIG. 1 exemplarily illustrates the gate driver 20 and the data driver 40 as separate components from the display panel 70, but at least one of the gate driver 20 and the data driver 40 may be configured integrally with the display panel 70 using an in-panel method in other embodiments. For example, the gate driver 20 may be formed integrally with the display panel 70 according to a gate in panel (GIP) type.

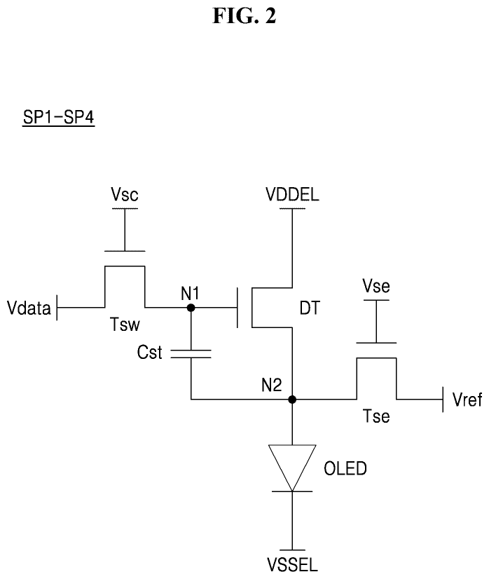

FIG. 2 is a schematic view illustrating a circuit of a sub-pixel of the display device according to an embodiment of the invention.

Generally, silicon-based semiconductor materials may include amorphous silicon (a-Si) or low-temperature polycrystalline silicon (LTPS). For example, the oxide-based semiconductor material may include an indium gallium zinc oxide (IGZO), an indium gallium zinc tin oxide (IGZTO), a zinc oxide (ZnO), a cadmium oxide (CdO), an indium oxide (InO), a zinc tin oxide (ZTO), a zinc indium tin oxide (ZITO), and the like and may also include a low-temperature polycrystalline oxide (LTPO). In addition, the transistor may be an oxide thin film transistor (TFT) including an oxide semiconductor or an LTPS TFT including low-temperature polysilicon (LTPS).

In addition, at least some or all of the transistors constituting each pixel PX may be formed as N-type transistors or P-type transistors.

Referring to FIG. 2, each of the switching transistor and the driver transistor may be implemented as an LTPS TFT, an oxide thin-film transistor, or an LTPO TFT.

The transistor is a three-electrode element including a gate, a source, and a drain. The source is an electrode for supplying carriers to the transistor. The carriers start to flow from the source in the transistor. The drain is an electrode through which the carriers move from the transistor to the outside. In the transistor, flows of the carriers flow from the source to the drain.

In an N-type transistor, since the carriers are electrons, the source voltage may be lower than the drain voltage to allow electrons to flow from the source to the drain. In the N-type transistor, a current flows in a direction from the drain to the source.

In a P-type transistor, since the carriers are holes, the source voltage is higher than the drain voltage to allow holes to flow from the source to the drain. In the P-type transistor, a current flows from the source to the drain because the holes flow from the source to the drain. It should be noted that the source and drain of the transistor are not fixed. For example, the source and the drain may be switched depending on the applied voltage. Accordingly, the embodiments of the invention are not limited by the relative position between source and drain of the transistor.

According to an embodiment, each of the first to fourth sub-pixels SP1 to SP4 of the display device 1 may include a switching transistor Tsw, a driving transistor DT, a sensing transistor Tse, a storage capacitor Cst, and a light-emitting diode OLED.

In FIG. 2, an example in which each of the first to fourth sub-pixels SP1 to SP4 has a 3T1C structure including three transistors and one capacitor is described, but in other embodiments, each of the first to fourth sub-pixels SP1 to SP4 may have one of a 6T1C structure including six transistors and one capacitor, a 7T1C structure including seven transistors and one capacitor, and an 8T1C structure including eight transistors and one capacitor.

In FIG. 2, an example in which all of the switching transistor Tsw, the driving transistor Tdr, and the sensing transistor Tse are of a N-type is described, but in other embodiments, at least one of the switching transistor Tsw, the driving transistor DT, and the sensing transistor Tse may be of a P-type.

According to an embodiment, the switching transistor Tsw may be switched according to a scan signal Vsc to transmit the data voltage Vdata to a first node N1.

A gate electrode of the switching transistor Tsw may be electrically connected to the gate line GL to receive the scan signal Vsc, a drain electrode of the switching transistor Tsw may be electrically connected to the data line DL to receive the data signal Vdata, and a source electrode of the switching transistor Tsw may be connected to the first node N1.

According to an embodiment, the driving transistor DT may be switched according to the voltage of the first node N1 to transmit the high potential signal (high potential voltage) VDDEL to a second node N2.

A gate electrode of the driving transistor DT may be electrically connected to the first node N1, a drain electrode of the driving transistor DT may be electrically connected to a high potential power line to receive the high potential signal VDDEL, and a source electrode of the driving transistor DT may be electrically connected to the second node N2.

According to an embodiment, the sensing transistor Tse may be switched according to the sensing signal (sensing voltage) Vse to transmit a reference signal (reference voltage) Vref to the second node N2 or transmit the voltage of the second node N2 to a reference line.

A gate electrode of the sensing transistor Tse may be electrically connected to the gate line GL to receive the sensing signal Vse, a drain electrode of the sensing transistor Tse may be electrically connected to the reference line to receive the reference signal (the reference voltage) Vref or transmit the voltage of the second node N2 to the reference line, and a source electrode of the sensing transistor Tse may be electrically connected to the second node N2.

According to an embodiment, the storage capacitor Cst may maintain the data voltage Vdata supplied to the first node N1 for one frame and store a threshold voltage of the driving transistor DT.

First and second capacitor electrodes of the storage capacitor Cst may be electrically connected to the first and second nodes N1 and N2, respectively.

According to an embodiment, the light-emitting diode OLED may emit light with a luminance proportional to the current of the driving transistor DT.

A positive electrode of the light-emitting diode OLED may be electrically connected to the second node N2, and a negative electrode of the light-emitting diode OLED may be electrically connected to a low potential power line to receive a low potential signal (a low potential voltage) VSSEL.

According to an embodiment, the source electrode of the switching transistor Tsw, the gate electrode of the driving transistor DT, and a first capacitor electrode of the storage capacitor Cst may constitute the first node N1, and the source electrode of the driving transistor DT, the source electrode of the sensing transistor Tse, a second capacitor electrode of the storage capacitor Cst, and the positive electrode of the light-emitting diode OLED may constitute the second node N2.

In this way, the light-emitting diode OLED may display an image having a luminance corresponding to image data according to the driving of the pixel circuits of the first to fourth sub-pixels SP1 to SP4.

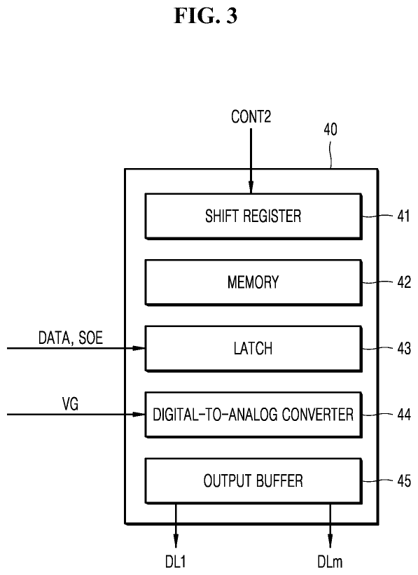

FIG. 3 is a block diagram illustrating a configuration of a data driver according to an embodiment of the invention.

Referring to FIG. 3, the data driver 40 may include a shift register 41, a memory 42, a latch 43, a digital-to-analog converter 44, and an output buffer 45.

According to an embodiment, the shift register 41 may generate a sampling signal using the data driving control signal CONT2 received from the timing controller 10. For example, the shift register 41 may generate a sampling signal from a source start pulse and a source sampling clock signal included in the data driving control signal CONT2 and generate a carry signal from the source start pulse.

According to an embodiment, the memory 42 may store the gamma compensation voltages corresponding to reference temperatures for each driving frequency and each band of the display panel 70. For example, the gamma compensation voltages corresponding to the reference temperatures according to each of the driving frequency and the band of the display panel 70 may be recorded in a register of the data driver 40 in an 8-bit size.

In addition, the memory 42 may store a plurality of offset values within a predetermined temperature range for optical compensation of the display panel 70.

According to an embodiment, the latch 43 may sequentially sample the digital image data DATA received from the timing controller 10 in response to the sampling signal. The latch 43 may latch the sampled data and then output all of the sampled data to the digital-to-analog converter 44 at once in response to a source output enable signal SOE input from the timing controller 10.

According to an embodiment, the digital-to-analog converter 44 may receive the gamma compensation voltage VG from the gamma generator 50, convert the sampled data output from the latch 43 according to the gamma compensation voltage VG, and output the converted data. The gamma compensation voltage VG is generated by the gamma generator 50 based on the control signal CSGCV transmitted from the data driver 40 to the gamma generator 50 based on the driving frequency and band of the display panel 70. Here, the gamma compensation voltages VG may include analog data voltages corresponding to each grayscale of the digital image signals RGB.

According to an embodiment, the output buffer 45 may output data voltages input from the digital-to-analog converter 44 to the data lines DL1 to DLm of the display panel 70 using a voltage follower implemented as an operational amplifier (OP-AMP).

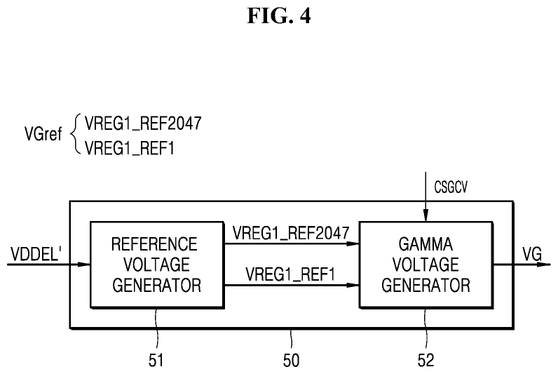

FIG. 4 is a view illustrating a configuration of a gamma generation unit according to an embodiment of the invention.

According to an embodiment, the gamma generator 50 may receive a feedback voltage VDDEL′ for the high potential driving voltage VDDEL applied to the display panel 70 and generate the gamma compensation voltage VG for compensating for the grayscale voltage based on the received feedback voltage VDDEL′.

Referring to FIG. 4, the gamma generator 50 may include a reference voltage generator 51 and a gamma voltage generator 52.

According to an embodiment, the gamma generator 50 may receive the feedback voltage VDDEL′ for the high potential driving voltage VDDEL applied to the display panel 70 from the display panel 70. The gamma generator 50 generates a gamma reference voltage VGref for generating the gamma voltage VG based on the received feedback voltage VDDEL′. The gamma reference voltage VGref may include, for example, a higher-level reference voltage VREG1_REF2047 and a lower-level reference voltage VREG1_REF1.

According to an embodiment, the gamma voltage generator 52 may generate the gamma compensation voltage VG from the gamma reference voltage VGref output from the reference voltage generator 51. For example, the gamma voltage generator 52 may generate a plurality of voltages by dividing voltages between the higher-level reference voltage VREG1_REF2047 and the lower-level reference voltage VREG1_REF1 and select a voltage indicated by a register setting value among the generated voltages to generate the gamma compensation voltages VG corresponding to each of the overall grayscales.

According to an embodiment, the gamma voltage generator 52 may receive the control signal CSGCV from the data driver 40 to generate the gamma compensation voltages VG. The control signal CSGCV causes the gamma generator 50 to generate the gamma compensation voltage VG based on temperatures according to the driving frequency and band of the display panel 70. The gamma voltage generator 52 may generate a plurality of voltages by dividing the voltages between the higher-level reference voltage VREG1_REF2047 and the lower-level reference voltage VREG1_REF1 and select the voltage indicated by the register setting value among the generated voltages to generate the gamma compensation voltages VG corresponding to each of the overall grayscales.

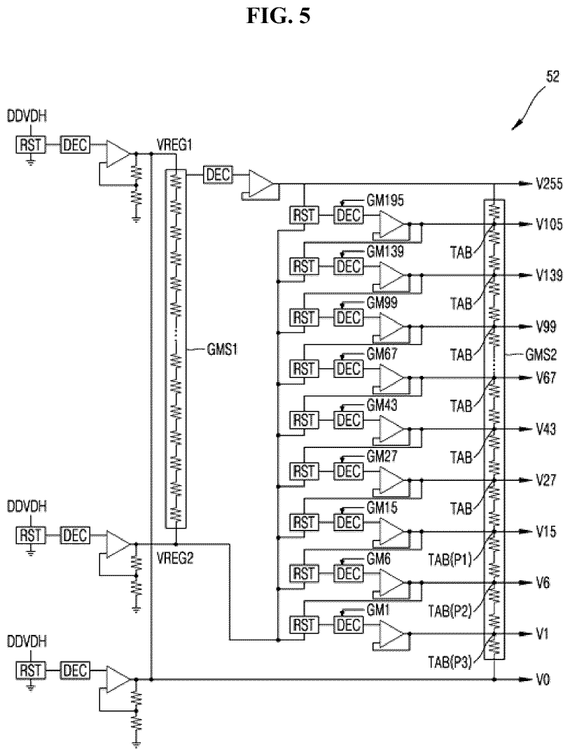

FIG. 5 is an exemplary view illustrating a configuration of a gamma voltage generator according to one embodiment of the invention.

Referring to FIG. 5, the gamma voltage generator 52 may include a resistor string RST, a decoder DEC, an input gamma string GMS1, an output gamma string GMS2, and a buffer.

According to an embodiment, the input gamma string GMS1 may be implemented as a resistor string electrically connected in series between a high potential voltage VREG1 and a low potential voltage VREG2. The high potential voltage VREG1 and the low potential voltage VREG2 may be varied by the resistor string RST and the decoder DEC, which each divide the driver driving voltage DDVDH.

According to an embodiment, the output gamma string GMS2 may be implemented as a resistor string electrically connected in series between a top-level gamma reference voltage V255 and a bottom-level gamma reference voltage V0. The gamma reference voltage may be referred to as a tab gamma voltage that is a voltage of a tab TAB of the output gamma string GMS2. The top-level gamma reference voltage V255 depends on a specific voltage divided from the input gamma string GMS1. The specific voltage divided from the input gamma string GMS1 may be varied by the decoder DEC. The bottom-level gamma reference voltage V0 may be varied by the resistor string RST that divides the driver driving voltage DDVDH and the decoder DEC.

According to an embodiment, the output gamma string GMS2 includes a plurality of tab grayscale points TAB. The output gamma string GMS2 may generate a plurality of gamma reference voltages V0 to V255 representing the voltages of the tab grayscale points TAB.

According to an embodiment, each of the tab grayscale points TAB are electrically connected to the resistor string RST, the decoder DEC, and the output buffer. The resistor string RST is electrically connected between the gamma reference voltage of an adjacent high-level tab grayscale point and the low potential voltage VREG2, and divides the gamma reference voltage of the adjacent high-level tab grayscale point TAB. The decoder DEC selects divided voltages corresponding to gamma values GM1 to GM195 recorded in the gamma resist memory of the data driver 40 and applies the selected divided voltage to the output buffer. The output buffer buffers the corresponding divided voltage and applies the divided voltage to the tab grayscale points TAB.

According to an embodiment, the gamma reference voltages V0 to V255 generated by the gamma voltage generator 52 may be provided to the digital-to-analog converter 44 of the data driver 40. These gamma reference voltages V0 to V255 may be generated by a control signal CSGCV (see FIG. 4) based on the driving frequency and band of the display panel transmitted from the data driver 40. In addition, the digital-to-analog converter 44 may convert digital data into analog data signals using the gamma reference voltages V0 to V255. When an image signal is supplied to a pixel, the digital signal is converted into an analog voltage suitable for the pixel, and the control of the signal voltage considering visibility between grayscales is referred to as “gamma control.”

Most gamma control methods use the gamma voltage generator 52 in the form of a resistor string and decoder DEC structure within the data driver 40. The gamma control performs optical compensation at a specific time point after the display device is driven and records gamma values in the gamma resist memory of the data driver 40 at the corresponding time points.

The optical compensation may find a value of the decoder DEC that satisfies a target value of luminance or color coordinates of each decoder DEC, and values between the decoders DEC, that is, between tab grayscale voltages, may be obtained through interpolation. The value of the decoder DEC may be the gamma values GM1 to GM195 recorded in the gamma resist memory.

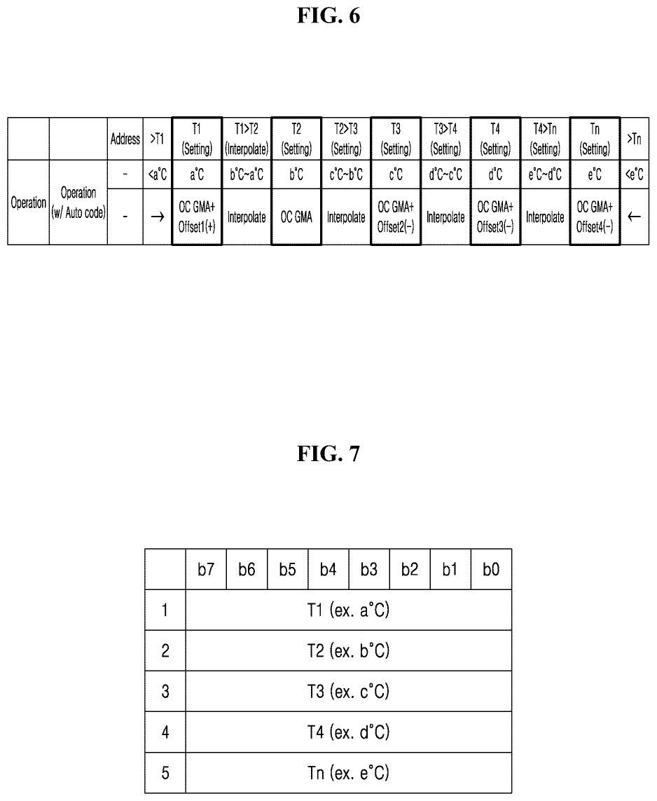

FIG. 6 is an exemplary view illustrating data voltages according to five temperatures stored in the data driver 40 according to an embodiment of the invention. FIG. 7 is an exemplary view illustrating five temperatures stored in the data driver 40 according to an embodiment of the invention.

Referring to FIGS. 6 and 7, data voltages Vdata for each of a plurality of temperatures (e.g., five temperatures) within a predetermined temperature range (e.g., e to a degree) may be previously recorded in the data driver 40. For example, one (e.g., T2) of the plurality of temperatures (e.g., T1 to Tn) may be set as a reference temperature, and the remaining temperatures may be set based on the reference temperature T2.

For example, when the reference temperature T2 is b degrees, T1=T2+α degrees, T3=T2−β degrees, T4=T2−γ degrees, and Tn=T2−δ degrees. Each of these five temperatures (e.g., T1 to Tn) may be stored in the memory 42 (or the register) of the data driver 40 within a size of 8 bits.

For example, when T2 is b degrees, T1=a degrees (i.e., T2+α degrees), T3=c degrees (i.e., T2-β degrees), T4=d degrees (i.e., T2-γ degrees), and Tn=e degrees (i.e., T2-δ degrees), where a, b, c, d, e, α, β, γ, and δ denote temperature values. In addition, according to embodiments, the temperatures for each of a, b, c, d, e, α, β, γ, and δ may be variably set.

For example, when the temperature of the display panel is 35 degrees, a data voltage obtained by linearly interpolating the data voltages for each of T1 and T2 may be used.

In addition, the memory 42 (or the register) of the data driver 40 may record offset values for each of the five temperatures (e.g., T1 to Tn) and the corresponding data voltages. For example, the offset value of T1 is +α, the offset value of T3 is −β, the offset value of T4 is −γ, and the offset value of Tn is −δ. In addition, the memory 42 (or the register) of the data driver 40 may record data voltages reflecting the offset values for each of the five temperatures (e.g., T1 to Tn). These offset values may be variably controlled.

In this way, the display panel operates at the same reference temperature to which the offset values are applied over all bands and all frequencies.

According to an embodiment, a frame rate for driving a moving image may be relatively high, such as a frequency of about 60 Hz or higher (e.g., 60 Hz, 72 Hz, 80 Hz, 96 Hz, 120 Hz, 240 Hz, etc.). As another example, the frame rate for driving a still image or the like may be relatively low, such as a frequency of less than about 60 Hz (e.g., 50 Hz, 40 Hz, 30 Hz, 10 Hz, 1 Hz, etc.).

In this way, the display device 1 requires a driving frequency of 60 Hz or higher in order to represent smooth motion in moving images with a large amount of image signal variation. There may be difficulties in lowering the driving frequency, even in consideration of aspects such as motion blur. However, in moving images with very little image signal variation or still images, the driving frequency can be reduced because the image is always constant without movement. However, since reducing the driving frequency too much may cause screen flicker, the image signal or image may be analyzed to adjust the driving frequency accordingly, rather than unconditionally reducing the driving frequency.

For example, when the display device 1 having a specific XGA resolution (1024×768) is driven at a general driving frequency of 60 Hz, the vertical synchronization signal may have a frequency of 60 Hz, the horizontal synchronization signal may have a frequency of 48.4 KHz, and the pixel frequency may have a frequency of 65 MHz.

The display device 1 may be driven, for example, at a driving frequency of 60 Hz in the general driving mode (or the first driving mode). Accordingly, a data voltage may be supplied to each sub-pixel disposed on the display panel 70 during a frame period corresponding to 60 Hz according to a synchronization signal (SYNC) of 60 Hz.

In addition, each sub-pixel exhibits luminance corresponding to a difference between a pixel voltage and a voltage of a common electrode according to a data voltage, enabling the display panel 70 to display an image.

In this case, the pixel voltage applied to the pixel electrode may decrease during one frame time. However, a decrease in luminance due to the decreased pixel voltage may not be recognized due to the short frame time.

Conversely, when the display device 1 is driven in a low-speed driving mode, such a decrease in luminance may be recognized since the length of one frame time is increased.

As illustrated in FIGS. 6 and 7, since the register of the data driver 40 has only one space for storing a predetermined number (e.g., five) of temperatures T1 to Tn, there is a need for an additional space for compensating for data voltages for each driving frequency and each band.

That is, the data driver 40 requires a storage space (e.g., the memory 42) for separately storing reference temperatures for each driving frequency and each band in a register, and during optical compensation, the temperature of the corresponding band may be stored in the storage space (e.g., the memory 42 or the register).

Accordingly, when a sample is driven, it is possible to accurately compensate for the data voltage for each band according to temperature, thereby minimizing luminance and color coordinate deviations.

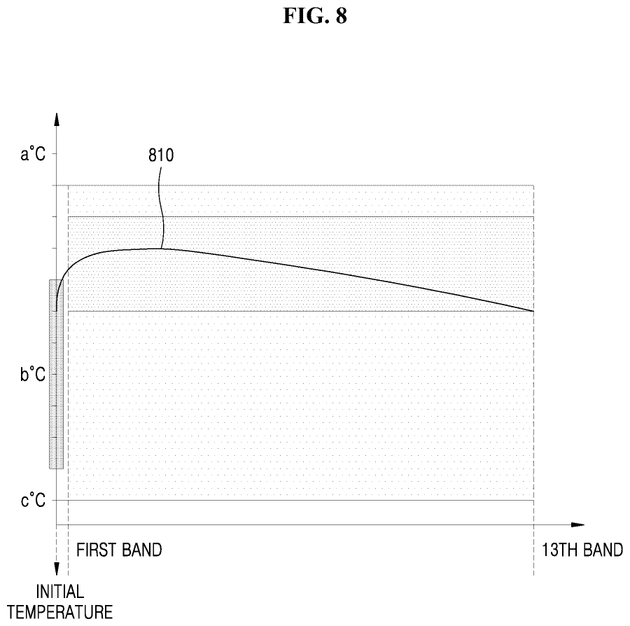

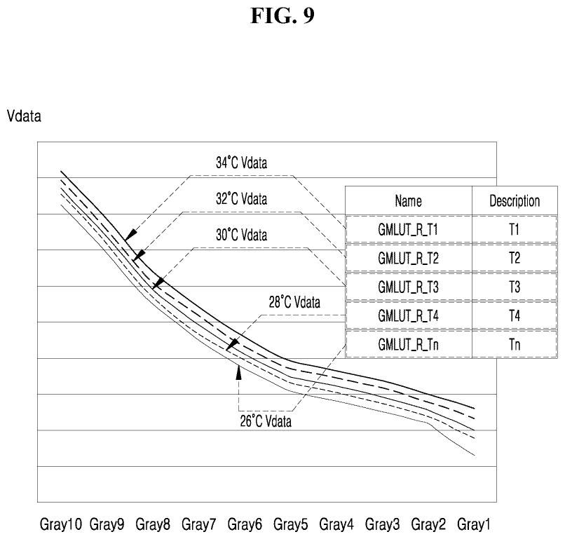

FIG. 8 is an exemplary graph illustrating an optical compensation temperature profile according to one embodiment of the invention. FIG. 9 is an exemplary graph illustrating a curve of data voltages stored in the data driver 40 according to an embodiment of the invention.

Referring to FIGS. 8 and 9, optical compensation is performed for the first to thirteenth bands Band1 to Band 13 at each of driving frequencies of 60 Hz and 40 Hz. During optical compensation, the panel can be affected by the equipment temperature or the self-heating of the panel during high-luminance emission, and the panel temperature may fluctuate during the process.

As illustrated in an optical compensation temperature profile curve 810 of FIG. 8, during optical compensation from the first to the thirteenth bands Band1 to Band13, the temperature initially rises (e.g., the first and second bands), but gradually decreases thereafter (e.g., the third to thirteenth bands).

As such, in the case of OLED display panels, temperature fluctuations cause fluctuations in luminance and color coordinates. In order to compensate for these fluctuations, the register of the data driver 40 stores a table (e.g., a gamma lookup table) that may allow the display panel to be driven with different data voltages for each temperature section. The number of gamma storage spaces in this table is a predetermined number (e.g., T1 to Tn), and each temperature section tab may be stored in the memory 42 (e.g., the register) of the data driver 40. That is, a sample temperature at the time of optical compensation may be stored in T2, a temperature obtained by adding α to T2 may be stored in T1, a temperature obtained by subtracting β from T2 may be stored in T3, a temperature obtained by subtracting γ from T2 may be stored in T4, and a temperature obtained by subtracting δ from T2 may be stored in Tn.

The data driver 40 may perform optical compensation for the plurality of temperatures (e.g., T1, T2, T3, T4, . . . Tn) within a predetermined temperature range (e.g., 15 to 40° C.) and then store data voltage deviations at each temperature in the lookup table. This lookup table may include data voltages for a predetermined number of sections (e.g., five) from T1 to Tn.

For example, a temperature at which the corresponding sample is optically compensated may be recorded in T2, a temperature at which α degrees are added to T2 may be recorded in T1, a temperature at which β degrees are subtracted from T2 may be recorded in T3, a temperature at which γ degrees are subtracted from T2 may be recorded in T4, and a temperature at which δ degrees are subtracted from T2 may be recorded in Tn.

Accordingly, a temperature during optical compensation for Band 5 is stored in T2, and gammas with the same offset value applied are stored in other tabs. In this case, all bands operate with the same reference temperature at which the offset value is applied. When an optical compensation temperature for Band 1 is 35° C., an optical compensation temperature for Band 5 is 32° C., and an optical compensation temperature for Band 13 is 28° C., 32° C. may be stored as the temperature of T2, resulting in a compensation deviation of +3° C. for Band 1 and −4° C. for Band 13.

In addition, since LTPO TFT panels exhibit luminance fluctuations due to temperature fluctuations to a degree greater than that of LTPS panels, a direction of luminance fluctuations at each luminance level may vary depending on temperature fluctuations. In addition, since the direction of luminance fluctuations at each luminance level varies depending on temperature fluctuations, data voltage compensation for each band and each frequency condition may be required.

When optical compensation is performed in the order of band, there is a temperature dispersion in the display panel for each band. As such, during optical compensation for a specific band, the greater the deviation between the display panel temperature and the reference temperature, there may be an error in the temperature compensation. That is, a degradation in temperature luminance sensitivity (TLS) and temperature color sensitivity (TCS) characteristics may occur.

Accordingly, there is a need to improve the TLS and TCS characteristics of a sample by setting reference temperatures for each band and each driving frequency.

To this end, the display panel 70 according to an embodiment of the invention provides the data driver 40 for storing the reference temperature T2 for each band in the memory 42.

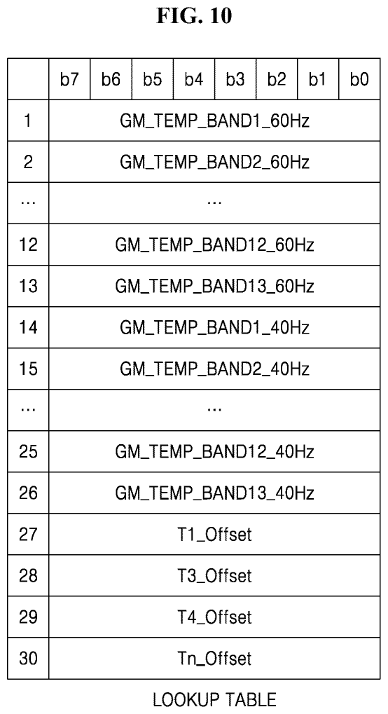

FIG. 10 is an exemplary view illustrating driving frequencies and band-specific reference temperatures stored in a memory of the data driver 40 according to an embodiment of the invention.

Referring to FIG. 10, the memory 42 of the data driver 40 stores a lookup table including the reference temperatures for each band and each driving frequency, and these reference temperatures for each band and each driving frequency may be recorded in the register of the memory 42.

For example, in the display panel 70, a reference temperature based on a driving frequency of 60 Hz and a first band may be recorded in a first register, and a reference temperature based on a driving frequency of 60 Hz and a second band may be recorded in a second register. Likewise, in the display panel 70, a reference temperature based on a driving frequency of 60 Hz and a third band may be recorded in a third register, and a reference temperature based on a driving frequency of 60 Hz and a fourth band may be recorded in a fourth register. In addition, when the driving frequency is 60 Hz, the reference temperatures for fifth to 13^{th} bands may also be recorded in fifth to 13^{th} registers, respectively.

In addition, in the display panel 70, a reference temperature based on a driving frequency of 40 Hz and a first band may be recorded in a 14^{th} register, and a reference temperature based on a driving frequency of 40 Hz and a second band may be recorded in a 15^{th} register. Likewise, in the display panel 70, a reference temperature based on a driving frequency of 40 Hz and a third band may be recorded in a 16^{th} register, and a reference temperature based on a driving frequency of 40 Hz and a fourth band may be recorded in a 17^{th} register. In addition, when the driving frequency is 40 Hz, the reference temperatures for the fifth to 13^{th} bands may also be recorded in the 18^{th} to 26^{th} registers, respectively.

In addition, the reference temperature (e.g., T2) and four temperatures (e.g., T1, T3, T4, Tn) in which an offset value is reflected in the reference temperature (e.g., T2) may be recorded in the register of the memory 42 of the data driver 40.

For example, when the driving temperature of the sample (e.g., the display panel) is 40° C., driving data voltages for each band may vary depending on each temperature section. The display panel operates at a voltage between the first band T1 (42° C.) and T2 (32° C.), and the compensation error is 0° C.

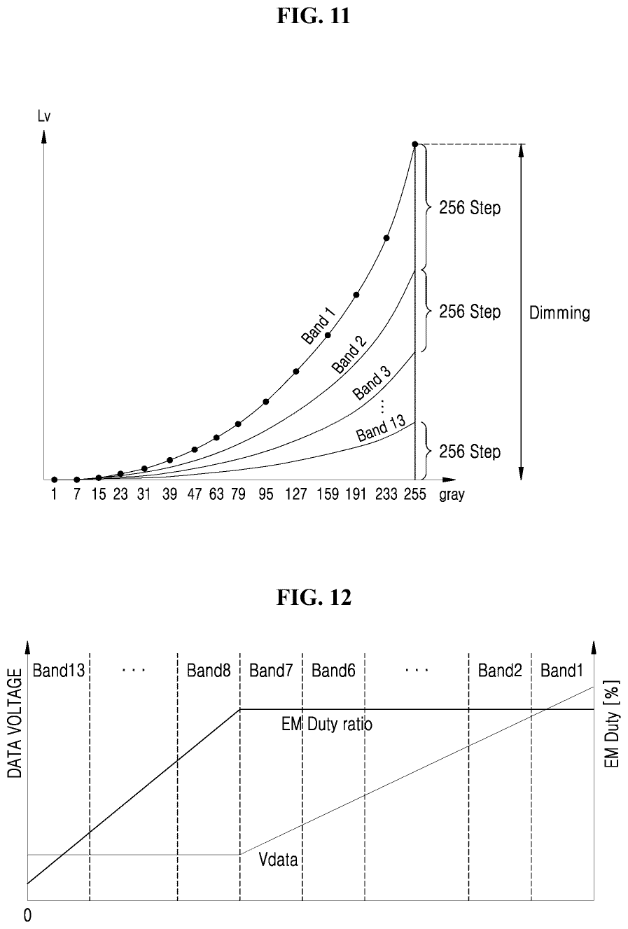

FIG. 11 is a graph illustrating band-specific dimming levels of pixel circuits in the display device according to an embodiment of the invention.

Referring to FIG. 11, the display panel 70 may include a plurality of bands Band 1, Band 2, Band 3, . . . , and Band 13 to apply different target luminances Lv according to the operating environment. The plurality of bands Band 1, Band 2, Band 3, . . . , and Band 13 may serve as references for adjusting dimming levels.

For example, a first band Band 1 may correspond to a setting for a situation requiring the highest maximum target luminance Lv depending on the ambient illuminance under daytime sunlight. A second band Band 2 may correspond to a setting for shaded area during daytime. A seventh band Band 7 may correspond to a setting for cloudy days, and an eighth band Band 8 may correspond to a setting under nighttime environments. In addition, a 13^{th} band Band 13 may correspond to a setting for darkroom environments. In addition, the bands may be further subdivided and categorized according to various usage environments and applications.

The plurality of bands Band 1, Band 2, Band 3, . . . , and Band 13 may have variable dimming levels to adjust luminance steps at specific grayscales. In addition, the target luminances Lv of the plurality of bands Band 1, Band 2, Band 3, . . . , and Band 13 may be set to have the same number of luminance steps. For example, the target luminance Lv of the first band Band 1 and the target luminance Lv of the second band Band 2 may differ by 256 steps.

The dimming level for adjusting luminance may vary from 0 to 100%. Even with the same grayscale, the dimming level may vary depending on the band, and thus the exhibited luminance may also vary.

For example, the maximum target luminance Lv of the first band Band 1 may have the dimming level of 100%. In addition, the dimming level may be adjusted by the data voltage applied to the pixel and adjusted according to a duty ratio of an emission signal EM(N).

A user may input a command to adjust the luminance of the display panel 70 using a finger or the like to change screen luminance (e.g., moving a luminance-adjusting scroll bar). In this case, the display panel 70 may select an appropriate digital luminance value according to the input command (e.g., moving the luminance-adjusting scroll bar) and recognize the selected luminance value as user input information.

The display panel 70 may include the plurality of luminance bands Band 1 to Band 13 to prevent white balance or color coordinates from being distorted when luminance is changed according to user input information. The number of luminance bands may vary depending on the model and disclosures of the display panel.

FIG. 12 is a view illustrating a method of adjusting band-specific dimming levels of the pixel circuits in the display device according to one embodiment of the invention.

Referring to FIG. 12, the dimming levels of the plurality of bands Band 1, Band 2, Band 3, . . . , Band 13 may be adjusted based on at least one of the data voltage Vdata applied to the pixel or the duty ratio of the emission signal EM(N).

In the plurality of bands Band 1, Band 2, Band 3, . . . , and Band 13, the maximum target luminance Lv of one band may be the same as the minimum target luminance Lv of the other band. For example, the minimum target luminance Lv of the first band Band 1 may be the maximum target luminance Lv of the second band Band 2.

Since the first to seventh bands Band 1, Band 2, . . . , and Band 7 have relatively high target luminances Lv, the grayscale-specific luminance variation may be large. In this case, since the luminance corresponds to the data voltage Vdata, the dimming level may be adjusted by varying the data voltage Vdata.

In the eighth to 13th bands Band 8, Band 9. . . , and Band 13, the target luminance Lv is relatively low, and the grayscale-specific luminance variation is small, and thus, when the dimming level is adjusted through the data voltage Vdata, the pixels may not operate properly. Accordingly, the dimming levels of the eighth to 13th bands Band 8, Band 9, . . . , and Band 13 may be adjusted through the duty ratio of the emission signal EM(N).

That is, in the first to seventh bands Band 1, Band 2, . . . , and Band 7, the duty ratio of the emission signal EM(N) is fixed, and the dimming level may be adjusted by varying the data voltage Vdata. In addition, in the eighth to 13th bands Band 8, Band 9, . . . , and Band 13, the data voltage Vdata is fixed, and the dimming level may be adjusted by varying the duty ratio of the emission signal EM(N).

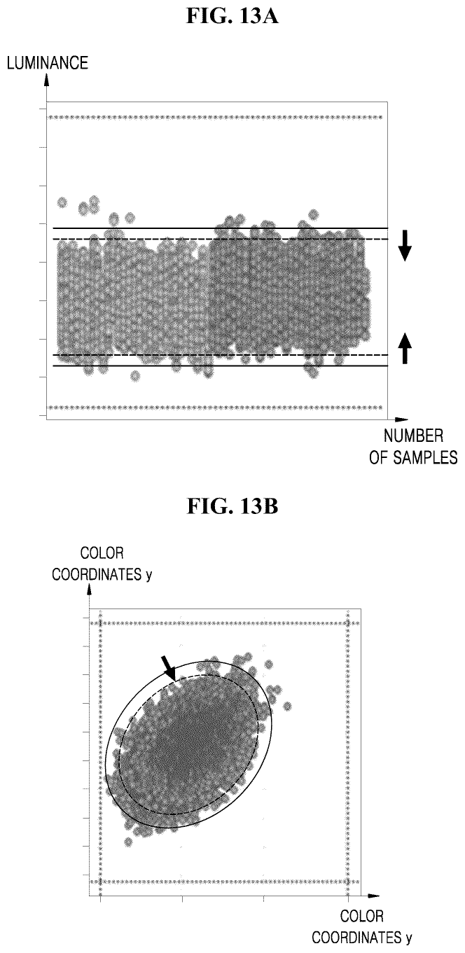

FIGS. 13A and 13B are views showing the results of reducing the dispersion of color coordinates and luminance through gamma compensation voltages corresponding to reference temperatures for each driving frequency and each band according to an embodiment of the invention.

Referring to FIGS. 13A and 13B, by storing the reference temperatures for each driving frequency and each band in the data driver 40, the temperature during optical compensation for each band and the compensation reference temperature during driving can be maintained identically. In addition, since the temperature during optical compensation and the compensation reference temperature during driving are the same, the accuracy of color coordinate and luminance compensation can be increased, and the dispersion of color coordinates and luminance in the inspection equipment can be improved.

In addition, even when the temperature dispersion increases as the optical compensation process is performed, the temperature compensation reference may be newly set for each band and compensation errors can be minimized, thereby increasing the degree of freedom in the temperature management range.

As described above, the display device according to embodiments the invention may include a register for setting temperature conditions for each driving frequency and each band in the register, thereby storing the gamma compensation voltages corresponding to the reference temperatures according to each driving frequency and each band in the data driver, and in addition, by storing various gamma compensation voltages, the accuracy of data voltage compensation can be increased, thereby minimizing luminance deviations.

Embodiments of the invention are directed to providing a display device capable of minimizing luminance deviations due to temperature fluctuations by increasing the accuracy of data voltage compensation.

In addition, embodiments of the invention are directed to providing a display panel capable of improving luminance sensitivity and color sensitivity characteristics of a sample by setting reference temperatures for each frequency and each band in order to reduce errors in temperature compensation that occur when a difference between a display panel temperature and a reference temperature increases during optical compensation in a specific band.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A display device comprising:
a display panel including a plurality of pixels, and gate lines and data lines electrically connected to each pixel;
a gate driver configured to transmit a gate signal to each pixel through the gate line;
a data driver configured to transmit a data voltage to each pixel through the data line; and
a gamma generator configured to generate a gamma compensation voltage based on a driver driving voltage,
wherein the data driver is configured to generate a control signal that causes the gamma generator to generate the gamma compensation voltage based on a driving frequency and band of the display panel, and transmit the generated control signal to the gamma generator.

2. The display device of claim 1, wherein the data driver is configured to:
acquire the gamma compensation voltage generated by the gamma generator based on the control signal; and
transmit the data voltage corresponding to the acquired gamma compensation voltage to each pixel through the data line.

3. The display device of claim 1, further comprising a timing controller configured to transmit an image signal and a data driving control signal to the data driver.

4. The display device of claim 3, wherein the data driver identifies a driving frequency for the image signal through the data driving control signal received from the timing controller.

5. The display device of claim 1, wherein the data driver includes a memory configured to store reference temperatures for each driving frequency and each band of the display panel.

6. The display device of claim 5, wherein the memory stores the reference temperatures for each driving frequency and each band of the display panel in a register.

7. The display device of claim 6, wherein the memory stores offset values for a plurality of temperatures within a predetermined temperature range for optical compensation of the display panel.

8. The display device of claim 7, wherein the data driver sets a plurality of reference temperatures based on driving frequency information and band information of the display panel and generates the data voltage by reflecting the offset values corresponding in each of the plurality of set reference temperatures.

9. The display device of claim 8, wherein the reference temperature is set for each band and stored in the memory.

10. A display device comprising:
a display panel including a plurality of pixels;
a data driver configured to transmit a data voltage to each pixel; and
a timing controller configured to transmit an image signal and a data driving control signal to the data driver,
wherein the data driver is configured to receive an identification signal for identifying a gamma compensation voltage based on a driving frequency and band of the display panel from the timing controller and identify the gamma compensation voltage based on the received identification signal.

11. The display device of claim 10, wherein the data driver is configured to:
identify the gamma compensation voltage based on the identification signal; and
transmit the data voltage corresponding to the identified gamma compensation voltage to each pixel.

12. The display device of claim 10, wherein the data driver includes a memory configured to set a plurality of reference temperatures based on driving frequency information and band information of the display panel and store gamma compensation voltages corresponding to each of the plurality of set reference temperatures.

13. The display device of claim 12, wherein the memory stores the gamma compensation voltages corresponding to the reference temperatures for each driving frequency and each band of the display panel in a register.

14. The display device of claim 12, wherein the data driver is further configured to:
acquire the gamma compensation voltage corresponding to image data displayed on the display panel from the memory; and
transmit the data voltage corresponding to the acquired gamma compensation voltage to each pixel through the data line disposed on the display panel.

15. The display device of claim 13, wherein the memory stores offset values for a plurality of temperatures within a predetermined temperature range for optical compensation of the display panel.

16. The display device of claim 15, wherein the data driver generates data voltages by reflecting offset values for each of the plurality of temperatures within the predetermined temperature range in reference temperatures according to each driving frequency and each band of the display panel.

17. The display device of claim 16, wherein the reference temperature is set for each band and stored in the memory.

18. A method of minimizing luminance and color coordinate deviation in pixels of a display panel in a display device including a data driver and a gamma generator, comprising:
generating, by the data driver, a control signal that causes the gamma generator to generate a gamma compensation voltage based on a driving frequency and band of the display panel;
transmitting, by the data driver, the control signal to the gamma generator;
generating, by the gamma generator, the gamma compensation voltage based on the driving frequency and the band of the display panel;
acquiring, by the data driver, the gamma compensation voltage based on the control signal; and
transmitting, by the data driver, a data voltage corresponding to the acquired gamma compensation voltage to each pixel through a data line.

19. The method of claim 18, wherein the data driver includes a memory storing reference temperatures for each driving frequency and each band of the display panel.

20. The method of claim 19, wherein the memory stores the reference temperatures for each driving frequency and each band of the display panel in a register.
